(19) United States
(12) Patent Application Publication
(10) Pub. No.: US 2009/0083064 A1
(43) Pub. Date: Mar. 26, 2009

(54) COMPETITIVE ONLINE PRESCRIPTION PRICING SYSTEM

(76) Inventor: David Mahinda, Union, NJ (US)

Correspondence Address: Elizabeth Waiguchu-Jackson, 1200 G Street, NW, Suite 800, Washington, DC, 20005, US

(21) Appl. No.: 11/859,951

(22) Filed: Sep. 24, 2007

(51) Int. Cl. G06Q 30/00

(52) U.S. Cl. 705/2

(57) ABSTRACT

A method and system for providing a transaction where a consumer with a valid refill for a prescription drug previously filled by a licensed pharmacist, wherein the consumer sends a bid for the prescription drug price to several participating pharmacies simultaneously online receives an offer from a pharmacy for the bid price submitted by the consumer or lower price. The transaction does not require the consumer to enter the patient's name, social security number, date of birth or address or prescription number. The consumer is required to select drug information. If the bid is accepted by a participating pharmacy the consumer presents the accepted offer to the pharmacy that accepted the bid.

### CROSS-REFERENCE TO RELATED APPLICATIONS

Not Applicable

### FEDERALLY SPONSORED RESEARCH

Not Applicable

### FIELD OF INVENTION

This invention relates to a method for obtaining competitive pricing for prescription drugs, specifically to an improved method for obtaining a discount price for a particular drug in one transaction.

### BACKGROUND OF THE INVENTION

In the present invention, the system provides a method for providing competitive pricing for various prescription drugs through secure online bid sent by a consumer to pharmacies located in selected zip codes.

As the cost of healthcare increases creative approach for providing consumers with convenient, safe and competitive prescription drug prices is necessary. The present invention saves the consumer money spent in healthcare. The present invention creates a safe and controlled environment for consumers to obtain their prescription drugs safely and competitively. The present invention also helps to create and an environment for pharmacies to have an opportunity to attract new customers to their store.

Participating pharmacies provide prescription discount offers where consumers are determined by factors including bid price, bid quantity, bid date and the selected zip codes. In the present invention, the consumer's information is not disclosed until a bid is accepted. Additionally, before the bid is accepted, the pharmacy's identity is not disclosed to the consumer. The price presented by each pharmacy is not disclosed to other pharmacies or consumers without bid offer. The pharmacies set the parameters of the consumers they are targeting for the bid. For instance, a pharmacy may allow bids for diabetic drugs for a particular month in a particular zip code for a particular period. The pharmacy may combine the bid with other offers to use in the store.

In the present invention the consumers have parameters to specify the area where they are willing to shop for the drug without providing their name, address or social security numbers.

Prescription drugs are by their nature best sold in an environment that allows the pharmacist to verify the authenticity of the prescription for the safety of the consumer. Thus, the present invention provides the consumer with an offer which must be verified by a licensed pharmacist before dispensing the product to the consumer. The invention provides the consumer with drugs that are approved and that are not expired or about to expire thus the expiration dates of the drugs are revealed to the consumer during the transaction.

In the present invention the participating pharmacies may control the types of drugs they are willing to offer for bids. For instance, a particular pharmacy may prefer to exclude all controlled substances or drugs that are prone to abuse from the bids. The dispensing pharmacist still remains actively involved to confer with the consumer and the physician to avoid bogus drug offers from being dispensed.

In the present invention the consumer is not charged a transaction fee for getting a discount. Instead, the pharmacy competing for the consumer's business pays a predetermined transaction fee for the service.

In this present system, a participating pharmacy may choose to offer one or multiple drugs for a designated number of consumers or for a designated period. Thus, a variety of pharmacies have an opportunity to attract new customers.

The present invention seeks to introduce a way for consumers without prescription coverage to get competitive drug prices.

### SUMMARY

In accordance with the present invention a computer implemented method of performing online prescription drug bid pricing by licensed pharmacies comprises a method of initiating a prescription drug bid, a method of accepting the bid by a participating pharmacy, a method of generating the accepted offer of the bid and a method of communicating details of the prescription offer for the bid to both the consumer and the pharmacy.

### BRIEF DESCRIPTION OF THE DRAWINGS

### Preferred Embodiment

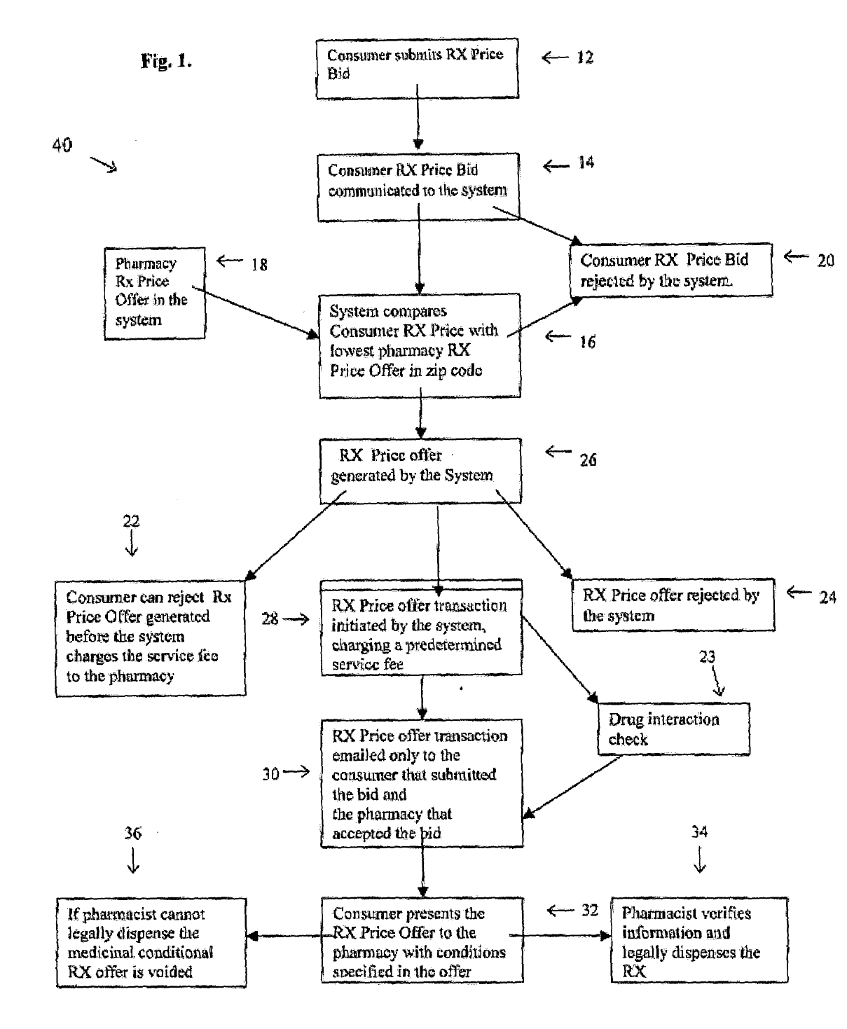

### FIGS. 1-4

FIG. 1 is a block diagram showing the steps of the system

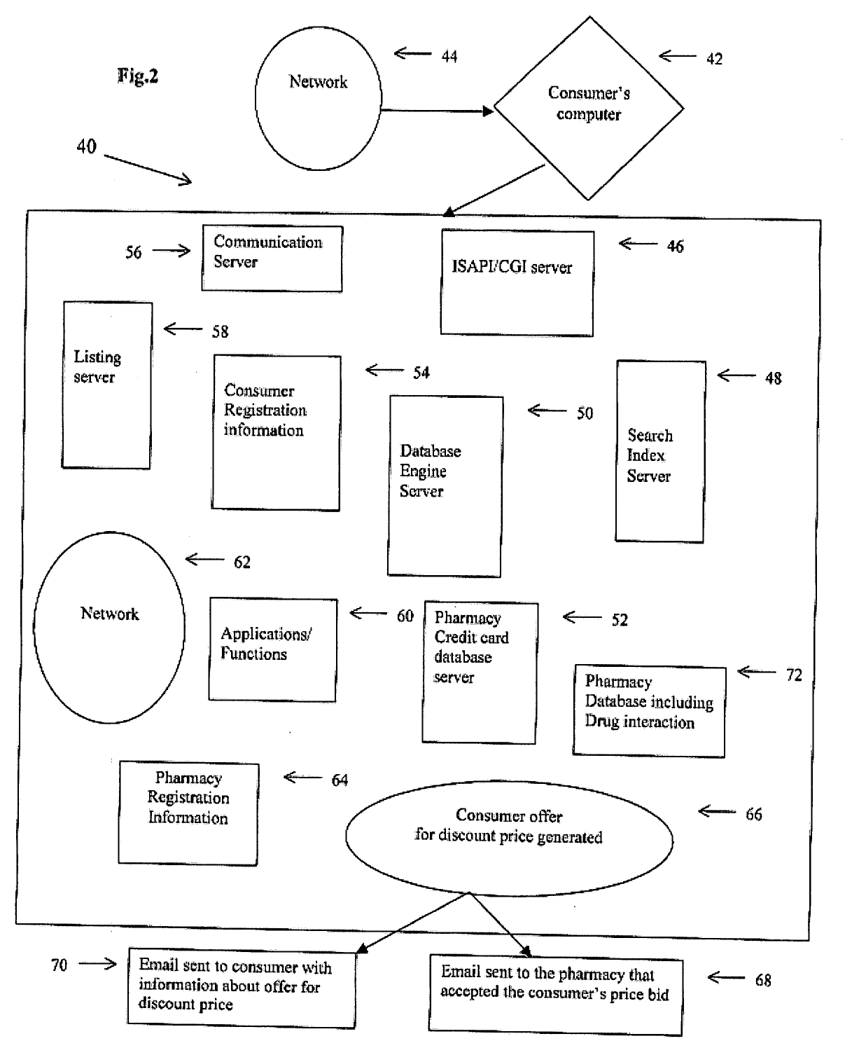

FIG. 2 is a block diagram of the electronic system

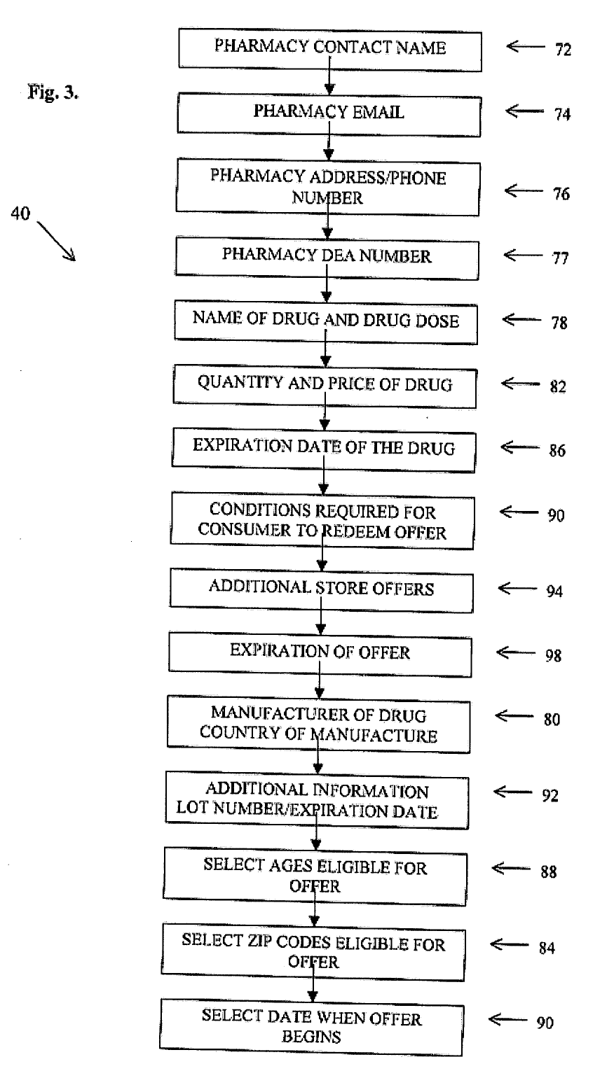

FIG. 3 is a block diagram of pharmacy registration

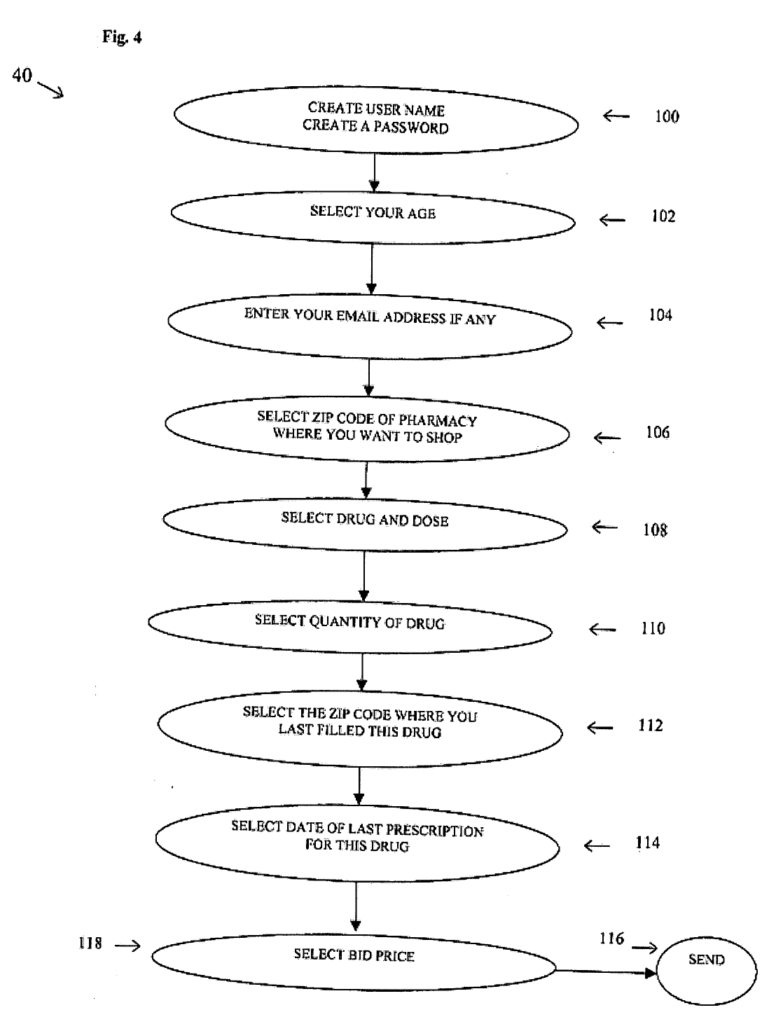

FIG. 4 is a block diagram of steps for consumer registration

The term RX refers to a prescription drug.

FIG. 1 shows how the RX price pricing wherein the user send a bid. In this embodiment the consumer is a user of the system 40 who initiates a bid 12 for prescription pricing. The identity of the consumer and the identity of the pharmacy 18 with RX Price Offers 26 are not disclosed to other pharmacies or the consumers. An Rx Price Offer 26 is generated and communicated to both parties. This information is not searchable by other pharmacies that were not matched up with the specific RX offer or other consumers not receiving the offer. Before submitting the RX price bid 12, the consumer is not required to submit their full name or address or birth date or phone numbers. The consumer however, must select qualifying listed information including age, drug with dosage, quantity of drug, zip codes for service. After the RX Price offer is generated by the system 26, the consumer has a predetermined time to cancel the order 22 or else the system transmits the RX Price offer information to next step of charging the pharmacy a predetermined transaction fee for the service. An RX Price offer ticket is generated 28 and emailed 30 to both the consumer and the pharmacy. The consumer prints the RX Price offer ticket 30 and presents it to the pharmacy 18 listed on the ticket along with the information required to legally fill the prescription by the pharmacist at the designated pharmacy. If a user enters multiple drugs for price bids, the user may choose to have a drug interaction check 23 by the system.

If RX Price offer is rejected by either the consumer 22 or the system 24, the system deletes all information submitted by the consumer. Consumer's information is not searchable by parties not involved in the transaction.

FIG. 2 is a block diagram of the preferred embodiment of the online discount pricing system according the present invention.

The system 40 includes a plurality of servers that deliver information to be displayed within Web pages, listing servers 58, ISAPI/CGI servers 46 and search servers 48 that handle search requests to the system 40. A communication server 56 provides automated e-mail communications to users of the system 40.

The system 40 further includes a database engine server 50, a search index server 48 and a credit card database server 52, each of which maintains and facilitates access to a respective database. The system 40 includes functions/applications 60 wherein the consumer is required to provide information in order to obtain the bid offer from the participating pharmacy 64 such as name of drug, dose and quantity of drug, zip code for desired pharmacy location, date of last fill of the drug, zip code of the pharmacy that previously dispensed the drug.

The web based pricing system 40 may be accessed by a user using a browser that executes on a machine 42 and accesses the system 40 via a network 44 such as the internet. The pricing system 40 provides listings of information including drug name, drug dose, drug quantity, expiration date of the drug, the expiration date of the offer. Once the bid is accepted by a participating pharmacy, the consumer receives information including the exact price offered by the pharmacy which is the price submitted on the bid or lower, the name, address and phone number of the pharmacy that accepted the bid 66.

The pharmacy accepting the bid is charged a predetermined transaction fee by the system 40. The system 40 allows the participating pharmacy to set parameters limiting number of offers generated by system over a specified period. Only pharmacies that have provided registration information 64 in the system 40, and have been matched up with a database of active licensed pharmacies 72 are included in the participating pharmacy list capable of accepting a bid from a consumer. The pharmacy database 72 includes information for checking drug interactions of drug selected for bids by the same user, if the user chooses to have the drug interaction check.

FIG. 3 shows pharmacy registration information in the system 40. The participating pharmacy must enter information 72,74,76,77,78,82,84,86,90,94,98,96,92,88,84,80 in the database of the system 40. For each drug and dose 78 entry offered to a consumer, the consumer is provided with pharmacy address/phone number 76, quantity and price of drug offered 82, expiration date of the drug offered 86, conditions required for a consumer to redeem offer 90, additional store offers 94 if any, expiration date of the offer 98, manufacture of drug and country of manufacture 96, additional information 92 and date when offer begins 80.

In FIG. 4, the registration information of a consumer in the system 40 is shown. A user must have internet access to use the system 40. A user must select information in the system 40 in order to get a successful prescription bid offer. The user starts by creating a valid user name and password 100. The user name and password 100 can be used to access the user's success bid information. The consumer is prompted to register certain information before the transaction for the bid begins. The user must select the age of the person who will take the drug 102. The user may choose to provide a contact email address 104. The user must select the zip code 106 of the area where they would like to pick up the drug. The user must select the drug and dose 108, quantity of drug 110 using the information from their previous prescription label from a pharmacy that had previously filled the prescription. The user selects the zip code 112 where they last obtained the prescription. The user is given an option to enter their email address 104 where they will receive email with the transaction information either rejecting the user's bid or an offer to accept user's bid from a pharmacy. If the user does not provide email address, the user may use the user name and later retrieve the transaction. The user must select the bid price or the price they are willing to pay for the drug selected and sends 116 the information for the system 40 to process. The system 40, using the information sent by the consumer and the information entered by the participating pharmacy finds the best matching offer based on price, user selected zip code, prior zip code where drug was filled 112, last date of prescription 114 and age 102. If the user has a contact email address available in the system 40, a confirmation of the offer is automatically sent to the address. The confirmation of the offer is also sent to the pharmacy that accepted the bid. Only the pharmacy accepting the bid from the user is provided with the transaction information.

What is claimed is:

1. A computer implemented method of performing online prescription drug bid pricing by pharmacies comprising:
listing a plurality of prescription drugs searchable by consumers via a Web page of a Web server for online search system;
accepting a bid from a registered user for a specific drug selected from a list via the Web page over a network;
distributing said bid to a plurality of participating pharmacies over the internet;
initiating a Prescription Price offer transaction;
matching the bid for the drug with at most one offer from a pharmacy selected from said participating pharmacies, said offer including an offer price specifying a prescription drug, price and a quantity and conditions at which the participating pharmacy will sell the drug to the user;
said matching occurring for a predetermined time period or until a suitable offer having an offer price less than or equal to said bid is received;
generating without intervention from the consumer, an RX Price offer transaction ticket if there is only one participating pharmacy having an offer price less than or equal to the bid price;
checking drug interactions;
displaying the generated Prescription Price Offer to the consumer that submitted the bid and the pharmacy that accepted the bid;
communicating the RX Price offer transaction to the consumer that submitted the bid and the pharmacy that accepted the bid.

2. The method of claim 1, comprising the step of:
listing a set of particular prescription drugs and,
operating a Web site with a catalog of participating licensed pharmacies offering prices on said listed drugs;

3. The method of claim 2, wherein said catalog of pharmacies offering said pricing is searchable using the Internet by registered users.

4. The method of claim 2, wherein said Web site comprises:
a directory of prescription drugs including drug name, drug dose, manufacturer of the drug, quantity of the drug offered at the specified price, expiration date of the drug, batch number of the drug, country of drug manufacture and the price.

5. The method of claim 4, wherein said catalog of pharmacies includes name, license number, address and phone number of the pharmacy listing said prescription drug.

6. The method of claim 1, wherein the user registers at the said website comprising:
entering a user name and a user password.

7. The method of claim 6, further comprising:
entering the user's bid of a particular drug selected from a list to be sent to participating pharmacies located in a zip code selected by the user.

8. The method of claim 7, further comprising:
selecting a set of user information including age, confirmation email, zip code where the prescription was last filled, date of last prescription fill for the drug and the zip code of participating pharmacies where the bid is sent, and
distributing said bid for said drug to a set of participating pharmacies found in zip codes selected by the user.

9. The method of claim 8, wherein distributing said bid for the drug to said set of participating pharmacies comprises creating a web page that specifies the bid and,
selecting at least one pharmacy specifying a price equal to or lower than the bid price.

10. The method of claim 1, wherein accepting the bid for said prescription drug from said user comprises receiving an HTML form.

11. The method of claim 1, further comprising:
initiating a Prescription Price offer transaction by system, charging a predetermined service fee and;
generating a Prescription Price Offer ticket, wherein said ticket includes the name, phone number and address of the pharmacy accepting the bid, bid expiration date and conditions for redeeming the offer.

12. The method of claim 11, wherein displaying the generated Prescription Price Offer further includes:
sending email specifying the details on the Prescription Offer ticket offers to said user and said pharmacy accepting the bid.

13. The method of claim 12, further comprising the step of:
allowing for a predetermined time period the user to reject the Prescription Price Offer,
and,
initiating a prescription Price offer transaction, and charging a predetermined service fee if the user does not reject the offer within the predetermined time.

14. The method of claim 1, wherein the participating pharmacy information is provided to the user after the pharmacy has accepted the user's bid.

15. The method of claim 1, said method further comprising:
accepting the user's registration information prior to accepting the bid from said user.

16. The method of claim 1, Further comprising the step of:
checking drug interactions wherein a user selects the option to check drug interactions between multiple drugs selected by the user for the bid.

17. A computer readable medium having stored thereon a set of instructions including instruction for prescription pricing initiated by a user sending a bid for a particular drug to a set of participating pharmacies, the instructions, when executed by a microprocessor cause the microprocessor to perform the steps of:
listing a set of prescription drugs, available for user's bid sent via a Web page of a Web server;
accepting a bid from a particular consumer for a particular drug order via the Web page over a network;
matching the bid for the drug with the pharmacy listing the particular drug order for the bid price or lowest price in the selected zip code;
generating a Prescription Price offer transaction ticket and charging a predetermined service fee to the pharmacy for the service;
distributing said Prescription Price Offer transaction information to the user and the pharmacy accepting the bid;
if there are multiple offers having an offer price less than to the bid price, presenting the user with the lowest price in the selected zip code;
checking drug interactions wherein a user selects the option to check drug interactions between multiple drugs selected by the user for the bid;
sending email specifying the details on the Prescription Offer ticket to said user and said pharmacy accepting the bid;
allowing for a predetermined time period the user to reject the Prescription Price Offer,
and,
initiating a prescription Price offer transaction, and charging a predetermined service fee if the user does not reject the offer within the predetermined time.
